(19) United States
(12) Patent Application Publication
(10) Pub. No.: US 2003/0007891 A1
(43) Pub. Date: Jan. 9, 2003

(54) Apparatus and method of detecting fluid

(76) Inventor: Robert F. Wilson, Roseville, MN (US)

Correspondence Address: James W. Inskeep, OPPENHEIMER WOLFF & DONNELLY LLP, Suite 700, 840 Newport Center Drive, Newport Beach, CA, 92660, US

(21) Appl. No.: 10/189,358

(22) Filed: Jul. 3, 2002

Related U.S. Application Data
(63) Continuation of application No. 09/378,285, filed on Aug. 20, 1999, now abandoned.

(51) Int. Cl. G01N 31/00

(52) U.S. Cl. 422/56; 436/56; 436/164; 427/2.12; 427/2.13; 422/57; 264/78; 264/500

(57) ABSTRACT

Designs and methods of manufacture are disclosed for a fluid detecting device. The fluid detecting device includes a colorant or dye used as the fluid indicator. When the dye comes into contact with the fluid, the reaction between the dye and the fluid is used to evaluate or detect the presence of fluid in the device. The reaction of the dye with the fluid may be detected using visualization, nephelometry, spectrophotometry, infrared detection, nuclear magnetic resonance spectroscopy or other techniques.

### FIELD OF THE INVENTION

The present invention relates to an apparatus and method of detecting fluid in a device. The present invention particularly relates to an apparatus and method of detecting fluid in a device using a colorant or dye.

### BACKGROUND OF THE INVENTION

Numerous industries in numerous applications use devices in which it is critical that monitoring for the presence of fluid occurs. Such monitoring is necessary in order to address concerns such as contamination, chemical imbalances, reusability and quality control.

For example, in a surgical operating room or catheterization lab where catheters, cannula and other medical grade tubing are used, the user must monitor that such tubing is not contaminated with fluid prior to use with a patient. This is particularly important with tubing that is reusable, where the risk of contamination may be greater.

Another example may be found in the food processing industry. Due to various inherent limitations in such processing as freezing, the user must monitor the water content to ensure that the foodstuff is processed safely.

A further example is found in the airline industry where the preflight procedure requires the checking and monitoring of the presence of water in the plane's fuel supply. Obviously it is important to ensure that the fuel does not contain a level of water that compromises the safe and continuous operation of the vehicle engines.

The devices and systems used in the above-described industries to address these concerns of fluid presence range from simple diagnostic mechanisms to elaborate control and correction apparatus. Some of these devices include those that are described in the following U.S. Pat. Nos.: 5,073,171; 5,103,817; 5,501,841; 5,564,425; and 5,755,689. However, there is an ongoing desire and need in these and other industries to improve and simplify the systems used to achieve the fluid monitoring goals. This is particularly true in the medical industry wherein most of the supplies used in treating patients are disposable. The economics of this industry require the use of a fluid monitoring system that is inexpensive to operate but provides the highest level of safety to the patient.

### OBJECTS AND SUMMARY OF THE INVENTION

In view of the foregoing, it is an object of the present invention to provide a fluid detector that addresses the obstacles and disadvantages associated with the current fluid monitoring practices.

A further object of the present invention is to provide a fluid detector that can indicate that the device has been previously used or has been in contact with a fluid, specific fluid or confirm that an exact volume of fluid has been infused into a system.

A further object of the present invention is to provide fluid detecting capabilities that are inexpensive, accurate and convenient for the user.

A further object of the present invention is to provide fluid detecting device whereby the fluid may be detected using visualization, nephelometry, spectrophotometry, infrared detection, nuclear magnetic resonance spectroscopy or other techniques.

These and other objects not specifically enumerated herein are sought to be addressed by the present invention which contemplates a fluid detector that includes a colored coating applied to a device, wherein the coating releases an amount of dye visible to a user of the device as fluid contacts the coating, thereby indicating that the device has contacted fluid. The coating or dye is used to indicate that the device has been previously used or in contact with a specific fluid or to confirm that an exact volume of fluid has been infused into a system.

Another embodiment of the present invention contemplates a single-use medical device having a fluid detector that includes a colored coating applied to the device that is used as a marking to indicate that the device is new and unused, whereby the colored coating is removed from the device by a flow of fluid that contacts the coating.

Another embodiment of the present invention contemplates a fluid detecting device that includes a pellet of dye attached to the device whereby the pellet releases an amount of dye visible to a user of the device as fluid passes through the device, thereby indicating that the device has contacted fluid.

Another embodiment of the present invention contemplates a fluid detecting device that includes a layer of fluid-soluble dye that contacts fluid so that when a volume of fluid flows over the layer of fluid-soluble dye an amount of dye is released into the fluid and is visible to a user of the device.

A further embodiment of the present invention contemplates a filter paper having fluid detecting means that includes a coating of dye applied to the top surface of the filter paper such that the coating of dye is removed as fluid passes through the porous material thereby indicating that the porous material has contacted fluid.

The present invention also contemplates a method of detecting the presence of fluid in a transparent device which may include the steps of coating an internal surface of the transparent device with an indicator dye and introducing a colorless fluid into the transparent device wherein the colorless fluid contacts the transparent device and the indicator dye. The final step would likely include observing the transparent device to determine contact between the colorless fluid and the indicator dye when the colorless fluid takes on a color of the indicator dye, such that the presence of color ensures that air has been removed from the transparent device thereby minimizing the potential occurrence of an air embolism in a patient.

The present invention further contemplates a method of detecting that the device has been flushed prior to use and may include the steps of coating an internal surface of the device with a colored dye and introducing a blood-compatible fluid into the device so that the blood-compatible fluid forms a colored fluid upon contact with the colored dye. The following step would include flowing a volume of the blood-compatible fluid through the device until the blood-compatible fluid removes the colored dye from the device. The final step would likely include visually observing the device to ensure that all of the colored dye has been removed.

A further object of the present invention is to provide a method of manufacturing an improved fluid detector that is efficient, easy to implement and cost effective.

The present invention further contemplates a method of manufacturing a fluid detecting device that may include the steps of forming a dye into a pellet and inserting the pellet into a cavity of an injection mold having a shape of the device. The following steps would include transmitting a melted resin into the cavity, such that the melted resin partially surrounds the pellet and then allowing the melted resin to cool and solidify. The final step would likely include ejecting the device from the mold, whereby the pellet is exposed on a surface of the device that contacts fluid so that when a volume of fluid flows over the pellet, the pellet releases an amount of dye into the fluid that is visible to a user of the device.

Another method of manufacturing a fluid detecting device would likely include the steps of filling a first screw area of a co-extrusion machine with a transparent resin and filling a second screw area of the co-extrusion machine with a dye-colored resin, whereby the dye-colored resin includes a dye that releases a stain upon contact with fluid. The next steps may include shearing the transparent resin between the first screw and a first wall that surrounds the first screw and shearing the dye-colored resin between the second screw and a second wall that surrounds the second screw. The following step would include heating and melting the transparent and dye-colored resins as they progress through the co-extrusion machine. The final step would likely include processing the transparent and dye-colored resins so that the transparent resin forms an external surface and the dye-colored resin forms an internal surface of the fluid detecting device, whereby the internal surface has contact with fluid so that when a volume of fluid flows over the internal surface, the dye-colored resin releases an amount of dye or stain into the fluid that is visible to a user of the device.

Another method of manufacturing a fluid detecting device would likely include the steps of forming a dye into a dry-film and inserting the dry film into a cavity of an injection mold having a shape of the device. The following step would likely include transmitting a melted resin into the cavity, such that the melted resin forms a layer over the dry film. The final step would likely include ejecting the device from the mold, whereby the dry film forms a surface of the device that contacts fluid so that when a volume of fluid flows over the dry film, the dry film releases an amount of dye into the fluid that is visible to a user of the device.

Another method of manufacturing a fluid detecting device would likely include the steps of forming a polymeric material into a shape of the device and applying a layer of dye onto the device. The following step would likely include heating the device so that the dye forms a vapor and diffuses into the polymeric material. The final step would likely include cooling the device such that the dye becomes a part of the device that contacts a fluid so that when a volume of fluid flows over the device an amount of dye is released into the fluid and is visible to a user of the device.

Another method of manufacturing a fluid detecting device would likely include the steps of applying a coating of dye onto a surface of a porous media and bonding the coating of dye to the surface such that the coating of dye is removed as fluid passes through the porous media thereby indicating that the porous media has contacted fluid.

### BRIEF DESCRIPTION OF THE DRAWINGS

Other features and advantages of the present invention will be seen as the following description of particular embodiments progresses in conjunction with the drawings, in which:

FIG. 1 is a cross-sectional view of a first embodiment of a fluid detecting device in accordance with the present invention;

FIG. 2 is a cross-sectional view of a second embodiment of a fluid detecting device in accordance with the present invention;

FIG. 3 is a cross-sectional view of a third embodiment of a fluid detecting device in accordance with the present invention;

FIG. 4a is a perspective view of a fourth embodiment of a fluid detecting device in accordance with the present invention;

FIG. 4b is a perspective view of a fourth embodiment of a fluid detecting device in accordance with the present invention; and

FIG. 5 is a perspective view of a fifth embodiment of a fluid detecting device in accordance with the present invention.

### DETAILED DESCRIPTION OF THE INVENTION

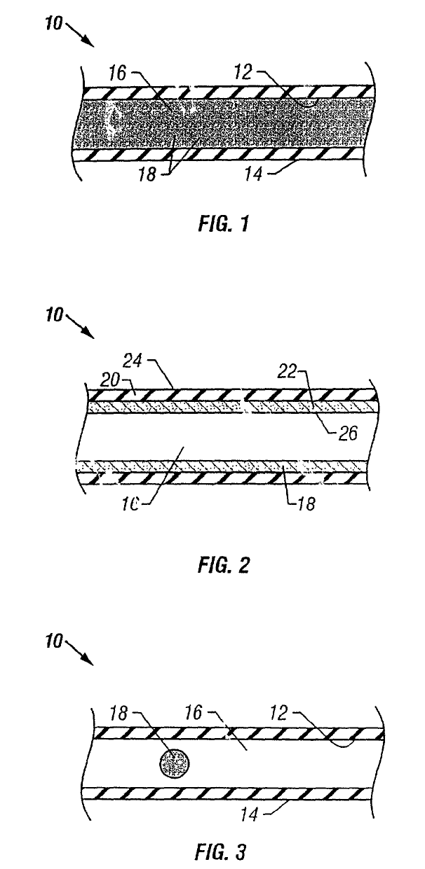

Referring to FIG. 1, a first embodiment of a fluid detecting device 10 in accordance with the present invention includes an internal surface 12 and an external surface 14. Typically, fluid (not shown) flows through the conduit or internal area 16 surrounded by the internal surface 12 and contacts the internal surface 12 of the device 10. A coating of colorant or dye 18 is applied to the internal surface 12 of the device 10 and is used to detect the presence of fluid.

The fluid detecting device 10 may be made of any material to which the dye 18 will adhere. In a preferred embodiment, the fluid detecting device 10 is initially substantially transparent, allowing a user to view the internal area 16 of the device 10. After the dye 18 is applied to the internal surface 12 of the device 10, the device 10 is less transparent and perhaps even substantially opaque and takes on the color of the dye 18. The presence of dye 18 on the internal surface 12 of the device 10 indicates that the device 10 is in an unused condition and that fluid has not contacted the internal surface 12 of the device 10.

Preferably, the entire internal surface 12 of the device 10 is coated with the dye 18. However, depending on the type of device 10 and its method of use, in some instances only a portion of the internal surface 12 is coated with dye 18.

In a preferred embodiment, the dye 18 is made of a substance that is blood-compatible or believed to be safe when delivered in small quantities to a human. These substances include, but are not limited to, indiocyanine green, reactive blue #2, evans blue, fluorescein dye or other fluorescing dyes, trypan blue, bromcresol green, bromcresol purple, methyl orange, B12, procion red, phenolphthalein, food dyes, such as FD&C Blue #1, FD&C Blue #2 and FD&C Red #3, or other colorants depending on the type of fluid to be detected. In addition, the dye 18 is soluble in the various fluids that would normally flow through the device 10, such as saline and water. As the dye 18 dissolves in the fluid, the dye 18 colors or stains the fluid so that the dye 18 and the fluid are substantially the same color. When detecting fluids such as hydraulic oils, alcohol or pure water, other dyes, such as any of the above mentioned dyes either separately or in combination, may also be used.

Preferably, the colorant or dye 18 is a substance that can be easily detected by a user of the device 10 through visual means and without additional detection equipment. Alternatively, other techniques, such as nephelometry, spectrophotometry, infrared detection, nuclear magnetic resonance spectroscopy or other techniques not specifically mentioned, may also be used in combination with such a dye 18 to detect the presence of fluid in the device 10.

A specific example of a fluid detecting device 10 as described above is medical tubing used to intravenously infuse saline into a patient. In this application, it is important for the user of the device 10 to be certain that all of the air has been completely removed from the device 10 prior to its use with the patient. This is typically accomplished by flowing a volume of fluid, such as saline, through the tubing prior to infusing the patient and thereby purging the tubing of residual air. Failure to remove air from the tubing can result in an air embolism forming within the patient which can prove fatal to the patient.

In its initial configuration, the tubing or device 10 is substantially transparent. When the manufacturing process is complete, the transparency has decreased and the device 10 displays the color of the dye 10 coated on its internal surface 12. The presence of the dye 18 indicates to a user that the device 10 is in an unused condition and has not contacted any fluids. Prior to use with a patient, a colorless fluid, such as saline, is introduced into the internal area 16 of the device 10. As the fluid contacts the dye 18 coated internal surface 12, the fluid causes the dye 18 to dissolve and stain the fluid the same color as the dye 18. During the flow of fluid through the internal area 16 of the device 10, the coating of dye 18 is eventually removed from the internal surface 12. During this process, the user of the device 10 visually observes the device 10 until the fluid is no longer stained and it appears that all of the dye 18 has been removed. When all the dye 18 has been removed from the internal surface 12 and the fluid is no longer stained, the device 10 returns to its initial substantially transparent configuration and thus is ready for connection to the patient. That is, the absence of dye 18 from the internal surface 12 of the device 10 indicates to the user that all the air has been removed and that the device 10 can be safely connected to the patient.

In an alternate configuration, the fluid causes the portion of the device 10 coated with dye 18 to change to a different color instead of simply washing away the dye 18. For example, in its initial configuration, the dye 18 may cause the color of the device to be blue. When fluid contacts the device, the color of the device then changes from blue to, for example, red. An example of a dye that could be used in this manner is phenolphthalein. In addition, this color change may be affected while the fluid substantially retains its original chemical properties and cosmetic appearance. An example of a fluid detecting device 10 of this configuration is an analytical fluid vessel, such as a cuvette. Other single-use devices 10, such as a syringe or pipette, also may use similar fluid-detecting capabilities. One such device, a cuvette, is more specifically discussed below.

During manufacture of a cuvette, a portion of the internal surface of the cuvette is coated with a layer of dye 18 while leaving a critical area or a cell window free of dye 18. For this application, it is important that the dye 18 does not react with the fluid so as to not interfere with the transmission or absorption of light during a reading. A volume of fluid injected into the cuvette causes the dye coated portion of the cuvette to change color. This color change is easily perceived by a user through visual means and indicates that the device has been used.

Other examples of different types of fluid detecting devices 10 of the present invention include balloon catheters or other catheter devices and semi-transparent gloves used during medical examination procedures, such as latex gloves. In particular with respect to semi-transparent gloves, in some instances it is difficult to ascertain whether examination gloves have been previously used, which is problematic given that reuse of single-use gloves may have potential health, safety and contamination risks.

To prevent reuse of disposable gloves, a fluid-reactive dye 18 is applied to the internal surface of the glove. When the glove is worn on a hand, moisture that is either present or which accumulates on the surface of the skin reacts with the dye 18 and stains the internal surface of the glove. The stain is visually observable by a user and indicates that the glove has been previously used, thereby preventing accidental reuse of the glove.

The fluid detecting device of the present invention may also be used in packaging applications. For example, during shipment of certain products it is helpful to know whether the products have come into contact with moisture. Due to the length of time between shipment and receipt of a product and the various environmental conditions to which the product is exposed during transit, it is difficult to accurately determine whether the packaging has prevented moisture from contacting the product. By applying a fluid-reactive coating of dye 18 to the internal surfaces of the packaging, the recipient of the package can readily determine if moisture has permeated the packaging barrier by visually inspecting the internal surfaces for dye 18 stains.

Another exemplary implementation of the invention is a medical connector that requires its internal surface 26 to be coated with a moist or lubris coating prior to assembly. Due to material characteristics and internal configurations of current connector designs, it is often difficult to confirm that a sufficient coating of lubricant or sealant has been properly applied to the internal surface 26. Hence, the connector is made with a layer which has a dye 18 present on or in the internal surface 26 of the connector. When the lubricant is applied to the internal surface 26 of the connector, the dye 18 reacts with the lubricant and stains the areas where the dye 18 and lubricant have come into contact. The user can then visually observe and thereby readily determine whether the connector has been adequately lubricated.

In contrast, the presence of a lubricant, such as silicone, on the internal surface of a syringe is often an undesirable manufacturing by-product. This is especially true when the syringe is used in medical applications, such as drug injections, and the patient is silicone-sensitive. To detect the presence of silicone, a fluid-reactant dye is mixed in the silicone used during the manufacture of the syringe. When fluid, such as a drug or medicine is drawn into the syringe, any traces of the silicone-dye mixture remaining in the syringe will react with the fluid. The reaction of the dye and fluid will result in a visible stain, indicating to a user that the device is contaminated with silicone.

FIG. 2 illustrates a second embodiment of the present invention. The function and principles of detection are analogous to the fluid detector described in FIG. 1, however, the fluid detecting device 10 of FIG. 2 is comprised essentially of two layers of material 20,22 formed from a co-extrusion process and an internal area 16. The first layer 20 forms an external surface 24 of the device 10 and the second layer 22 forms the internal surface 26. When a fluid is introduced into the device 10, it flows through the internal area 16 and contacts the internal surface 26 of the second layer 22.

The preferred material for the two layers 20,22 is PVC with indicator material loaded into the compound in high concentrations and virgin PVC, although other materials such as polyurethanes or other extrudable resins may also be used. The second layer 22 of material also includes a dye 18 that has been impregnated into the material or integrated into the material composition during the manufacturing process (e.g. co-extrusion). The co-extrusion process is discussed in greater detail below.

As in the previous embodiment shown in FIG. 1, the dye 18 functions as a fluid detector so that when a volume of fluid contacts the internal surface 26 of the device 10, color from the dye 18 is released into and stains the fluid. Alternatively, a dye 18 could be used such that when the fluid contacts the internal surface 26, the second layer 22 of the device 10 changes color and the fluid retains its original color.

In another preferred embodiment of the present invention, the dye 18 selectively reacts to fluids having certain properties or characteristics (e.g. contrast media, saline, medicaments, etc.). When such a fluid is introduced into the device 10 and contacts the internal surface 26, the dye 18 releases a pigment that stains the fluid having the particular property or characteristic but does not change any of the properties of the fluid. The user can then visually observe and thereby determine when a specific fluid has been infused into the device 10. Exemplary dyes 18 for this function are indiocyanine which will stain the clear fluid green.

Such a device 10 is particularly useful in the airline industry as a tool in the performance of the preflight procedure where a pilot must check for the presence of water in the plane's fuel supply. This is typically accomplished by drawing an amount of fuel out of a fuel tank into a clear vial and carefully inspecting the vial to see if there is a layer of water floating on the surface of the fuel. Because both the fuel and the water are clear in color, it is often difficult to readily ascertain whether there is any water in the fuel. By coating a portion of the internal surface 26 of the vial with a transparent dye 18 that has a selective affinity to water, a user is able to accurately and reliably determine whether there is water present in the fuel by visually inspecting the vial for the presence of dye 18 stains.

A third embodiment of the present invention is shown in FIG. 3. The fluid detecting device 10 comprises an elongate, transparent tube that includes an internal surface 12, an external surface 14 and an internal area 16. A dye 18 manufactured to take the shape of a pellet is attached to the internal surface 12 of the device 10. Attachment could be achieved by creating a receptacle for the pellet in the internal wall of the tube, adhering the pellet with an appropriate adhesive or by providing a fluid permeable chamber into which the pellet could be placed. As in the first embodiment, when fluid flows through the internal area 16 and contacts the pellet of dye 18, the dye 18 stains the fluid. The pellet of dye 18 dissolves in the fluid and is subsequently removed from the device 10 by the fluid contacting the pellet. The volume of fluid required to remove the dye 18 from the device 10 is proportional to the size of the pellet. Therefore, the dye 18 can be used not only to detect the presence of fluid, but also to measure the volume of fluid that contacts or flows through the device 10.

This embodiment of the present invention is particularly useful in the food processing industry in light of the fact that a critical step in the manufacture of processed foods is the addition of a specific volume of water to the food products. Due to the complexity of equipment used to manufacture processed foods, it is often difficult to accurately determine that a sufficient amount of water has been added to the food. By attaching an appropriately sized pellet of dye 18 to the internal surface of the module used to deliver the water, a manufacturer can readily determine when an adequate amount of water has been added to the food product.

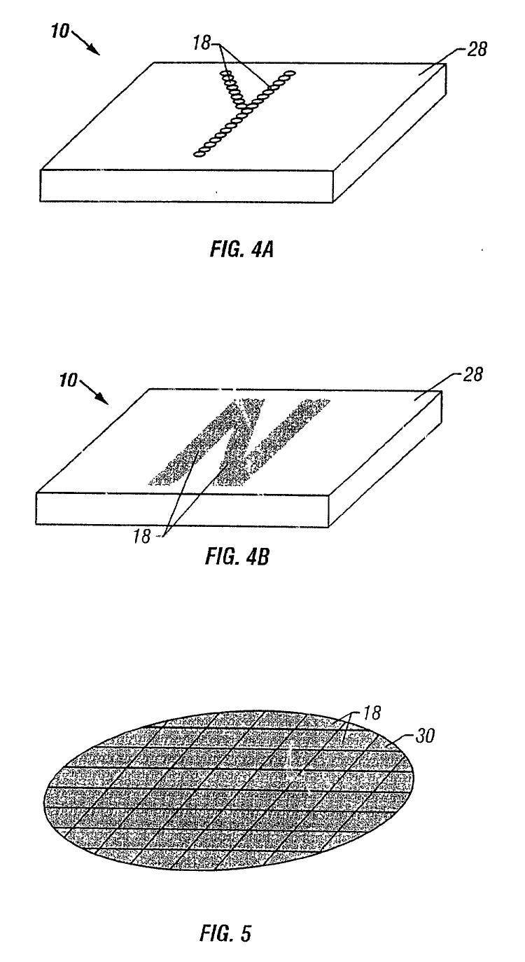

FIGS. 4a and 4b illustrate a fourth embodiment of the present invention, wherein the coating of dye 18 consists of multiple layers that are arranged in varying thicknesses and patterns along the surface 28 of the device 10. In a preferred embodiment, the patterns and thicknesses may form specific words, commands, symbols, shapes, logos or other similar designs. When fluid contacts the dye 18, the dye 18 coated surface 28 of the fluid detecting device 10 changes color.

An example of such a fluid detecting device 10 is a coated microscope slide, shown in FIGS. 4a and 4b. Layers of dye 18 or layers of different types of dyes 18 are applied to the surface of a microscope slide in specific patterns and thicknesses. The patterns, thicknesses, and types of dye 18 produce specific reactions to certain properties of the fluid. For example, as shown in FIG. 4a, when a fluid with acidic properties is applied to the microscope slide, the fluid reacts with the appropriate dye 18 and produces a visibly detectable stain on the slide having a particular shape, such as the letter “Y.” However, when a fluid with basic properties is introduced, a visibly detectable stain having a particular shape for a particular dye, such as the letter “N,” is produced on the slide, as shown in FIG. 4b.

A fifth embodiment of the present invention is illustrated in FIG. 5. A dry rigid film of dye 18 is applied to a porous medium 30, such as filter paper or comparable materials, in a manner similar to the in-mold decorating process that is well known in the industry. The flow of fluid through the filter paper 30 produces a visible stain on the medium. The presence of the stain indicates to a user of the device 10 that the filter paper 30 has been previously used.

Method of Manufacturing

The present invention also contemplates a method of manufacturing a fluid detecting device 10 in accordance with the present invention. In this connection, the liquid dye 18 may be applied to the device 10 using an ink-jet applicator or air spray equipment, such as air guns, high pressure low vapor (HVLP) equipment, air brushes or texture guns.

A first step of manufacturing the fluid detecting device 10 includes filling the pressure pot or supply pump of a sprayer with a liquid dye 18. The pressure pot or supply pump is used to provide a constant steady flow of dye 18.

The next step involves aligning the sprayer with the device 10 so that the nozzle of the sprayer is in close proximity to the internal surface of the device 10. The distance between the end of the nozzle and the surface of the device 10 depends upon the configuration of the sprayer and the nozzle. For example, low pressure sprayers typically require less distance between the spray nozzle and the surface of the device 10 than high pressure sprayers.

The following steps include activating the sprayer so that the liquid dye 18 forms a vapor and dispensing the vapor onto the device 10 in the form of a coating. The coating can include a single layer of dye 18 or multiple layers. In addition, the coating can be applied in layers forming various patterns and thicknesses, depending upon how the device 10 is to be used.

The final assembly step would likely include drying the coating of dye 18 on the internal surface of the device 10. The dye 18 can be dried by using air, heat or other similar means, depending on the type of dye 18 used and the material properties of the device.

The present invention also contemplates another method of manufacturing a fluid detecting device 10. The first step includes forming a dye 18 that easily dissolves in fluid into the shape of a pellet or film. The remainder of the manufacturing process will only refer to the pellet configuration, however, it is implied that the same process is also used with the film configuration. In a preferred embodiment, the dye 18 is in powder form. However, alternative forms, such as dry paste or extruded powder, may also be used. The structure of the pellet can be formed using molding, extrusion, or other similar processes well known in the industry.

The following steps include inserting the pellet into a cavity of an injection mold and transmitting a melted resin into the cavity of the mold. The cavity of the injection mold is in the shape of the fluid-detecting device. To ensure optimum contact with the fluid in the resulting device 10, the pellet is placed in a specific location of the cavity. An amount of melted resin is dispensed inside the cavity of the mold in order to form the device. This resin partially surrounds the pellet. Note, for the film configuration of the dye, the resin surrounds the film such that either the entire internal surface of the resin is fully covered or only selected areas (i.e. stripes) are covered.

The final assembly steps would likely include allowing the melted resin to cool and solidify and ejecting the finished device 10 from the mold. The resin can be allowed to naturally cool to room temperature or a cold fluid, such as air, can be supplied to the outside of the mold to accelerate the cooling process. After the device 10 has solidified, it can be safely ejected from the mold.

The present invention contemplates another method of manufacturing a fluid detecting device 10. The first step includes filling the first and second screw areas of a co-extrusion machine with transparent and dye-colored resins, respectively. The resins can be solid or semi-solid organic products of natural or synthetic origin, generally of high molecular weight with no definite melting point. In a preferred embodiment, the transparent resin is a thermoplastic with water clear color, such as PVC, and the dye-colored resin is also a thermoplastic with a water clear color in its un-dyed state, such as polyurethane, that becomes dye-colored when dye 18 is added to the resin. The dye 18 of the dye-colored resin releases a stain when it contacts a fluid.

The next steps involve shearing the transparent resin between the first screw and its wall and shearing the dye-colored resin between the second screw and its wall. During the shearing process, the screws force the resins down the barrel of the co-extrusion machine. The resins are cut and compressed between the root of the screws and the walls that surround them.

The following step involves heating and melting the resins. The extrusion process produces frictional energy that heats and melts the resins as they are conveyed down the barrel of the co-extrusion machine.

The final step would likely include processing the resins so that the transparent resin forms an external surface and the dye-colored resin forms an internal surface of the fluid detecting device 10. The dye 18 forming a portion of the material of the dye-colored resin is used as the fluid detector.

Another method of assembling a fluid detecting device 10 is also contemplated by the present invention. The first step includes forming a polymeric material, such as polycarbonate, thermoplastic or thermoset materials, into the shape of the fluid detecting device 10. The device 10 includes an internal surface and an external surface, whereby the internal surface is configured to have contact with a fluid.

The next steps include applying a layer of dye 18 onto the internal surface of the device 10 and heating the device 10 so that the dye 18 forms a vapor and diffuses into the polymeric material: The dye is printed, sprayed or painted on the internal surface using techniques well known in the industry. The application of beat causes the molecules of the material of the device 10 to expand and change the dye 18 into a vapor. With the molecules of the material in an expanded state, the vapor is able to penetrate into the material of the device 10.

The final assembly step would likely include cooling the device 10 so that the dye 18 becomes an integral part of the material comprising the internal surface of the device 10.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method of detecting the presence of fluid in a substantially transparent medical device comprising the steps of:
applying an indicator dye to an internal surface of said transparent device;
introducing a fluid into said substantially transparent device wherein said fluid contacts said internal surface of said substantially transparent device and said indicator dye; and
observing said substantially transparent device to determine contact between said fluid and said indicator dye wherein said fluid takes on a color of said indicator dye, and wherein the presence of said color is an indicator that air is being removed from said substantially transparent device.

2. The method of detecting the presence of fluid in a transparent device of claim 1 wherein said device is medical tubing.

3. The method of detecting the presence of fluid in a transparent device of claim 1 wherein said device is an analytical fluid vessel.

4. The method of detecting the presence of fluid in a transparent device of claim 1 wherein said fluid is saline.

5. The method of detecting the presence of fluid in a transparent device of claim 1 wherein said dye is blood compatible.

6. A method of detecting that medical tubing has been flushed prior to use comprising the steps of:
applying a colored dye to an internal surface of said tubing during fabrication of said tubing;
introducing a blood-compatible fluid into said tubing so that said blood-compatible fluid is colored upon contact with said colored dye;
flowing a volume of said blood-compatible fluid through said tubing until said blood-compatible fluid is no longer covered by said colored dye; and
visually observing said tubing to ensure that said blood-compatible fluid is no longer colored by said colored dye.

7. The method of claim 6 wherein said dye is indiocyanine green.

8. A method of detecting the presence of a specific fluid in a substantially transparent device comprising the steps of:
applying an indicator dye to an internal surface of said substantially transparent device, said indicator dye being reactive to fluids having at least one specific property;
introducing a fluid into said substantially transparent device such that said fluid contacts said indicator dye; and
determining that said fluid has said at least one specific property when said fluid reacts with said indicator dye.

9. The method of detecting the presence of a specific fluid in a substantially transparent device of claim 8 wherein said device is a syringe.

10. The method of detecting the presence of a specific fluid in a substantially transparent device of claim 8 wherein said fluid is fuel.

11. The method of detecting the presence of a specific fluid in a substantially transparent device of claim 8 wherein said dye is phenolphthalein.

12. A single-use medical device having a fluid detector comprising:
an elongate tube having an internal surface and an external surface; and
a colorant applied to said internal surface;
said colorant being an indicator to a user that said device is in an unused state and that fluid has not contacted said internal surface of said tube;
said colorant being removable from said internal surface of said tube by a flow of fluid that contacts said colorant.

13. The single-use medical device of claim 12 wherein said colored coating is indiocyanine green.

14. A method of coating a surface of a medical device with a fluid detector comprising the steps of:
filling an ink jet applicator with a dye that dissolves in fluid;
aligning said ink jet applicator with said surface of said device;
activating said ink jet applicator so that said dye is placed substantially into a vapor state;
directing said dye onto said surface to form at least one layer of dye, said at least one layer having a thickness which requires a predetermined volume of fluid to remove said at least one layer of dye during use of the device; and
drying said coating of dye on said surface of said device.

15. A method of coating a surface of a medical device according to claim 14, wherein said step of directing said dye onto said surface includes applying said at least one layer in a pattern on to said surface.

16. The method of coating a surface of a medical device with a fluid detector of claim 14 wherein said dye is indiocyanine green.

17. A microscope slide having a fluid detector comprising:
a microscope slide having a top surface and a bottom surface; and
a coating of dye applied to said top surface in varying thicknesses and patterns, such that when a fluid contacts said surface a portion of said coating reacts with said fluid and displays a stain of a particular pattern.

18. The microscope slide of claim 17 wherein said pattern forms letters of a word.

19. The microscope slide of claim 17 wherein said dye is indiocyanine green.

20. A method of manufacturing a fluid detecting device comprising the steps of:
forming a pelletized dye;
inserting said pelletized dye into a cavity of a mold having a shape of said device;
transmitting malleable resin into said cavity, such that said malleable resin partially surrounds said pelletized dye;
allowing said resin to solidify into the form of said device; and
ejecting said solidified resin from said mold, said pelletized dye being exposed on a surface of said device that contacts fluid so that when a volume of fluid flows over said pelletized dye, said pelletized dye releases an amount of dye into said fluid.

21. The method of manufacturing a fluid detecting device of claim 20 wherein said pelletized dye is made of indiocyanine green.

22. A fluid detecting device comprising:
an elongate tube having an internal surface and an external surface; and
a pelletized dye fixed to said internal surface at a location such that said pelletized dye is in contact with fluid during use of said device;
said pelletized dye comprising a dye visible to a user of said device as fluid passes through said tube, thereby indicating that said device has contacted said fluid.

23. The fluid detecting device of claim 22 wherein said pelletized dye is indiocyanine green.

24. A method of manufacturing a fluid detecting device comprising the steps of:
filling a first screw area of a co-extrusion machine with a first resin;
filling a second screw area of said co-extrusion machine with a dye-colored resin, said dye-colored resin including a dye that releases a stain upon contact with a fluid;
shearing said first resin between a first screw and a first wall that surrounds said first screw;
shearing said dye-colored resin between a second screw and a second wall that surrounds said second screw;
melting said first resin and said dye-colored resin as said resins progress through said co-extrusion machine; and
processing said first resin and said dye-colored resin so that said first resin substantially forms an external surface of said fluid detecting device and said dye-colored resin substantially forms an internal surface of said fluid detecting device, said internal surface having contact with fluid during use of said device so that when a volume of fluid flows over said internal surface, said dye-colored resin releases an amount of said dye into said fluid that is visible to a user of said device.

25. The method of manufacturing a fluid detecting device of claim 24 wherein said first resin is thermoplastic with water clear color.

26. The method of manufacturing a fluid detecting device of claim 24 wherein said dye-colored resin is a thermoplastic with water clear color in its un-dyed state that becomes dye-colored when dye is added to the resin.

27. The method of manufacturing a fluid detecting device of claim 24 wherein said dye is indiocyanine green.

28. A fluid detecting device in the shape of an elongate tube comprising:
a first layer substantially forming external surface;
a second layer substantially forming an internal surface having a dye as part of its material composition, said dye exhibiting a first color of said second layer; and
an internal area surrounded by said internal surface such that said dye causes said second layer to exhibit a second color upon contact of said internal surface with a fluid.

29. The fluid detecting device of claim 28 wherein said dye is indiocyanine green.

30. A method of manufacturing a fluid detecting device comprising the steps of:
forming a dissolvable dye into a dry-film form;
inserting said dry film into a cavity of an injection mold having a shape of said device;
transmitting a melted resin into said cavity, such that said melted resin forms a layer over said dry film; and
ejecting said device from said mold, said dry film being exposed on and forming a surface of said device that contacts fluid so that when a volume of fluid flows over said dry film, said dry film releases an amount of dye into said fluid that is visible to a user of said device.

31. The method of manufacturing a fluid detecting device of claim 30 wherein said dye is indiocyanine green.

32. A method of manufacturing a fluid detecting device comprising the steps of:
forming a polymeric material into a shape of said device, said device having an internal surface and an external surface, said internal surface having contact with fluid during use of said device;
applying a layer of dye onto said internal surface of said device;
heating said device so that said dye forms a vapor and diffuses into said polymeric material such that during use of said device, an amount of said dye is released into said fluid and is visible to a user of said device.

33. The method of manufacturing a fluid detecting device of claim 32 wherein said polymeric material is PVC.

34. The method of manufacturing a fluid detecting device of claim 32 wherein said dye is indiocyanine green.

35. A fluid detecting device comprising:
an elongate tube having a first layer and a second layer, said first layer forming a substantially transparent external surface of said tube and said second layer forming an internal surface of said tube, said internal surface including a layer of fluid-soluble dye in contact with a fluid so that when a volume of fluid flows over said internal surface, said fluid-soluble dye releases an amount of dye into said fluid that is visible to a user of said device.

36. The fluid detecting device of claim 35 wherein said dye is indiocyanine green.

37. A filter paper having fluid detecting means comprising:
a porous material having a top surface and a bottom surface; and
a coating of dye applied to said top surface such that said coating of dye produces a stain on said porous media when fluid passes through said porous material thereby indicating that said porous material has been used.

38. The filter paper of claim 37 wherein said dye is indiocyanine green.
